(19) United States
(12) Patent Application Publication
(10) Pub. No.: US 2024/0191444 A1
(43) Pub. Date: Jun. 13, 2024

(54) MANURE COLLECTING VEHICLE

(71) Applicant: Nuhn Industries Ltd., Sebringville (CA)

(72) Inventor: Ian NUHN, Stratford (CA)

(73) Assignee: Nuhn Industries Ltd., Sebringville, ON (CA)

(21) Appl. No.: 18/518,785

(22) Filed: Nov. 24, 2023

Related U.S. Application Data
(60) Provisional application No. 63/431,357, filed on Dec. 9, 2022.

(51) Int. Cl. E01H 1/00; A01K 1/01; A47L 7/00; A47L 9/00; A47L 9/06; A47L 9/14; E01H 1/08

(52) U.S. Cl. CPC E01H 1/006; A01K 1/0128; A47L 7/009; A47L 9/0072; A47L 9/009; A47L 9/066; A47L 9/149; E01H 1/0827

(57) ABSTRACT

A manure collecting vehicle includes: a manure collector having a manure collection port and at least one powered rotational manure conveyer to convey manure to the manure collection port as the vehicle drives through the manure; a manure holding tank in manure communication with the manure collection port, collected manure passing through the manure collection port into the manure holding tank as the vehicle drives through the manure; and, an air system to create an air pressure differential between inside the manure holding tank and outside the manure holding tank when the vehicle is driving through the manure to be collected so that the collected manure passes from the manure collection port into the manure holding tank under influence of the air differential.

### CROSS-REFERENCE TO RELATED APPLICATIONS

This application claims the benefit of United States Provisional Patent Application U.S. Ser. No. 63/431,357, filed Dec. 9, 2022, the entire contents of which is herein incorporated by reference.

### FIELD

This application relates to agriculture, in particular to manure handling.

### BACKGROUND

Manure collecting vehicles are vehicles that are propelled through alleyways in large livestock (e.g., cattle) barns to clean the alleyways of manure. Such vehicles may be self-propelled or trailers towed by a prime mover (e.g., a tractor or a truck). Manure is collected by a manure collector at the front of the vehicle as the vehicle moves down the alleyway, the collected manure transferred to a manure holding tank on the vehicle. Once collected, the manure is generally transported to a different site where the manure is deposited out a rear hatch on the manure holding tank.

Typical manure collecting vehicles have a manure collector at a rear of the vehicle, the manure collector channeling manure into one or more ports from where the manure is transferred to a manure holding tank. Once the manure is collected in the holding tank, the manure is discharged from the holding tank through a rear hatch on the vehicle. Manure can be solid, liquid or almost any consistency in between forming a slurry of solids suspended in water, the water content dictating the consistency of the slurry. Manure slurries are corrosive and abrasive and have variable consistency making the slurries difficult to handle and requiring equipment adaptability from one operation to another and even within the same manure handling operation. It would therefore be beneficial to have a manure collecting vehicle that can be adapted on-the-fly to efficiently handle manure of any consistency.

Thus, there remains a need for a manure collecting vehicle that can more efficiently collect and discharge manure from a variety of different barn alleyways under a variety of different manure conditions.

### SUMMARY

A manure collecting vehicle comprises: a manure collector having a manure collection port and at least one powered rotational manure conveyer configured to convey manure to be collected to the manure collection port as the vehicle drives through the manure to be collected; a manure holding tank mounted on a vehicle chassis, the manure holding tank in manure communication with the manure collection port, the collected manure passing through the manure collection port into the manure holding tank as the vehicle drives through the manure to be collected; and, an air system configured to create an air pressure differential between inside the manure holding tank and outside the manure holding tank when the vehicle is driving through the manure to be collected so that the collected manure passes from the manure collection port into the manure holding tank under influence of the air pressure differential.

As used herein, the term “manure” also encompasses other materials that may be present in the manure to be collected. Such other materials may be, for example, straw, hay, dirt and any other material.

In some embodiments, the manure collector is mounted on the vehicle chassis at a front of the vehicle with respect to direction of motion of the vehicle during a manure collection operation. In some embodiments, the manure collector comprises a center arm mounted on the vehicle. In some embodiments, the center arm has a pair of frontwardly and laterally extending arm sections joined at an apex proximate the vehicle chassis. In some embodiments, the manure collection port is situated proximate the apex. In some embodiments, the manure collection port is situated in a front face of the center arm.

In some embodiments, the manure collector comprises a pair of end arms. Preferably, at least one of the end arms, more preferably both of the end arms, is pivotably mounted to the center arm. In some embodiments, at least one of the end arms, preferably both end arms, is pivotably mounted to a respective one of the extending arm sections at the distal ends thereof. Preferably, at least one of the end arms, more preferably both of the end arms, are pivotable about a respective vertical axis so that distal ends of the end arms move horizontally and laterally with respect to the direction of motion of the vehicle. In some embodiments, the vehicle further comprises at least one pair, preferably two pairs of arm actuators, configured to pivot at least one of the end arms, preferably both of the end arms, about the respective vertical axes, each pair of arm actuators comprising an inner arm actuator and an outer arm actuator mounted in series with the inner arm actuator through a common pivot plate. Preferably, the inner arm actuator pivotally mounted to a rear face one of the arm sections. Preferably, the outer arm actuator is pivotally mounted to a rear face of the end arm that is connected to the arm section to which the inner arm actuator is mounted. In some embodiments, the distal ends of the end arms further comprise guide wheels connected to the pivoting scrapers. The guide wheels are preferably configured to contact and roll on inward facing faces of alleyway edges as the vehicle drives down an alleyway.

In some embodiments, the distal ends of the end arms comprise scrapers. In some embodiments, the manure to be collected is guided toward the manure collection port by the end arms and the extending arm sections during the manure collection operation. In some embodiments, the manure collector is tiltable so that the distal ends of the end arms are vertically higher than the distal ends of the arm sections.

In some embodiments, the at least one powered rotational manure conveyer comprises at least one auger. In some embodiments, the at least one powered rotational manure conveyer comprises at least two powered rotational manure conveyers. In some embodiments, the at least two powered rotational manure conveyers conveying manure along each of the extending arm sections from distal ends thereof to the manure collection port. In some embodiments, the at least one powered rotational manure conveyer comprises a variable speed motor that drives the conveyer at different speeds. In some embodiments, the powered rotational manure conveyer comprises an auger.

In some embodiments, the manure collection comprises a gate operable to change the size of the manure collection port. In some embodiments, the gate is located in front of the manure collection port and is raisable and lowerable to open and close the manure collection port. In some embodiments, the manure collector comprises one or more gate actuators connected to the gate, the one or more gate actuators configured to move the gate to change the size of the manure collection port. For handling thick and/or heavy manure, the gate is preferably more opened to make the manure collection port larger. For handling liquid manure, the gate is preferably more closed. Preferably, the gate is raisable to a more opened position to enlarge the effective size of the manure collection port and lowerable to a more closed position to reduce the effective size of the manure collection port. Further, the ability to reduce the effective size of the manure collection port permits collecting as much residual manure as possible at the end of an alleyway after collecting operation in order to leave as little manure behind as possible.

In some embodiments, the manure collector is vertically adjustable relative to the vehicle chassis. In some embodiments, the manure collector comprises one or more collector actuators connecting the manure collector to the vehicle whereby actuation of the one or more collector actuators vertically adjusts the manure collector relative to the vehicle chassis. In some embodiments, the one or more collector actuators also tilt the manure collector so that the distal ends of the end arms are vertically higher than the distal ends of the arm sections. In some embodiments, the manure collector comprises one or more pivotal linking bars for mounting the manure collector on the vehicle chassis.

In order to create the air pressure differential, the air system may be configured to lower the air pressure inside the manure holding tank compared to outside the manure holding tank or the air system may be configured to raise the air pressure outside the manure holding tank compared to inside the manure holding tank so that so that the collected manure passes from the manure collection port into the manure holding tank.

In some embodiments, the manure holding tank comprises a tank outlet and the air system is configured to raise the air pressure inside the manure holding tank compared to outside the manure holding tank so that the collected manure inside the manure holding tank is ejected through the tank outlet. Alternatively, or additionally, the tank outlet is in manure communication with a mechanical manure transporting apparatus (e.g., an auger, a belt or the like) to transport the collected manure, especially thick manure, out of the manure holding tank. In some embodiments, the air system comprises a blower assembly having a blower, a silencer and a cooling box. In some embodiments, the cooling box is plumbed to provide both a cooling air inlet and an exhaust outlet through a same inlet/outlet conduit. In some embodiments, the blower assembly comprises a four-port valve that selectively creates a dual inlet when the blower assembly is in discharge mode. In some embodiments, the components of the blower assembly are co-located in a cutout in a side of the holding tank.

In some embodiments, the vehicle further comprises a shut-off valve provided between the manure collection port and the manure holding tank in manure communication with the manure collection port, the shut-off valve operable so that a manure handling conduit connecting the manure collection port to the manure holding tank does not spill or drip manure after the manure collection operation.

In some embodiments, the vehicle further comprises an engine for operating driven components of the vehicle so that the vehicle is self-propelled. In some embodiments, the vehicle further comprises an operator cab containing controls from which an operator can control the vehicle. In some embodiments, the vehicle can be controlled remotely and the vehicle comprises one or more imaging systems (e.g., cameras) so that a remote operator can control where the vehicle is driven.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a front perspective view of a manure collecting vehicle.

FIG. 2A depicts a perspective view of a manure collector of the manure collecting vehicle of FIG. 1.

FIG. 2B depicts detail A in FIG. 2A.

FIG. 3A depicts the manure collector of FIG. 2A with one of a pair of end arms pivoted to a different position.

FIG. 3B depicts detail B in FIG. 3A.

FIG. 4A depicts the manure collector of FIG. 3A the one end arm pivoted to yet a different position.

FIG. 4B depicts detail C in FIG. 3A.

FIG. 5A depicts a front elevational view of the manure collector of FIG. 3A with a gate of a manure collection port in a more closed position.

FIG. 5B depicts detail D in FIG. 5A.

FIG. 5C depicts a rear elevational view of the manure collector of FIG. 5A.

FIG. 5D depicts detail E in FIG. 5C.

FIG. 5E depicts a top view of the manure collector of FIG. 5A without a shut-off valve.

FIG. 5F depicts section F1-F1 in FIG. 5E.

FIG. 5G depicts a top view of the manure collector of FIG. 5A.

FIG. 5H depicts section F2-F2 in FIG. 5G.

FIG. 6A depicts the manure collector of FIG. 5A with the gate of the manure collection port in a more opened position.

FIG. 6B depicts detail G in FIG. 5A.

FIG. 6C depicts a rear elevational view of the manure collector of FIG. 6A.

FIG. 6D depicts detail H in FIG. 5C.

FIG. 6E depicts a top view of the manure collector of FIG. 6A without a shut-off valve.

FIG. 6F depicts section 11-11 in FIG. 6E.

FIG. 6G depicts a top view of the manure collector of FIG. 6A.

FIG. 6H depicts section 12-12 in FIG. 6G.

FIG. 7A depicts the manure collector of FIG. 6A without the gate and showing augers rotatably mounted to a center arm of the manure collector.

FIG. 7B depicts a top view of the manure collector of FIG. 7A.

FIG. 7C depicts detail J in FIG. 7A.

FIG. 7D depicts section K-K in FIG. 7B.

FIG. 8A depicts a side view of the manure collecting vehicle of FIG. 1 with the manure collector in a lowered position.

FIG. 8B depicts a top view of the manure collecting vehicle of FIG. 8A.

FIG. 8C depicts section L-L in FIG. 8B.

FIG. 8D depicts detail M in FIG. 8C.

FIG. 9A depicts a side view of the manure collecting vehicle of FIG. 1 with the manure collector in a raised position.

FIG. 9B depicts a top view of the manure collecting vehicle of FIG. 9A.

FIG. 9C depicts section N-N in FIG. 9B.

FIG. 9D depicts detail O in FIG. 9C.

FIG. 10A depicts a perspective view of the manure collecting vehicle of FIG. 1 illustrating an air system with a blower assembly of the manure collecting vehicle.

FIG. 10B depicts a top view of the manure collecting vehicle of FIG. 10A.

FIG. 100 depicts detail P in FIG. 10B.

### DETAILED DESCRIPTION

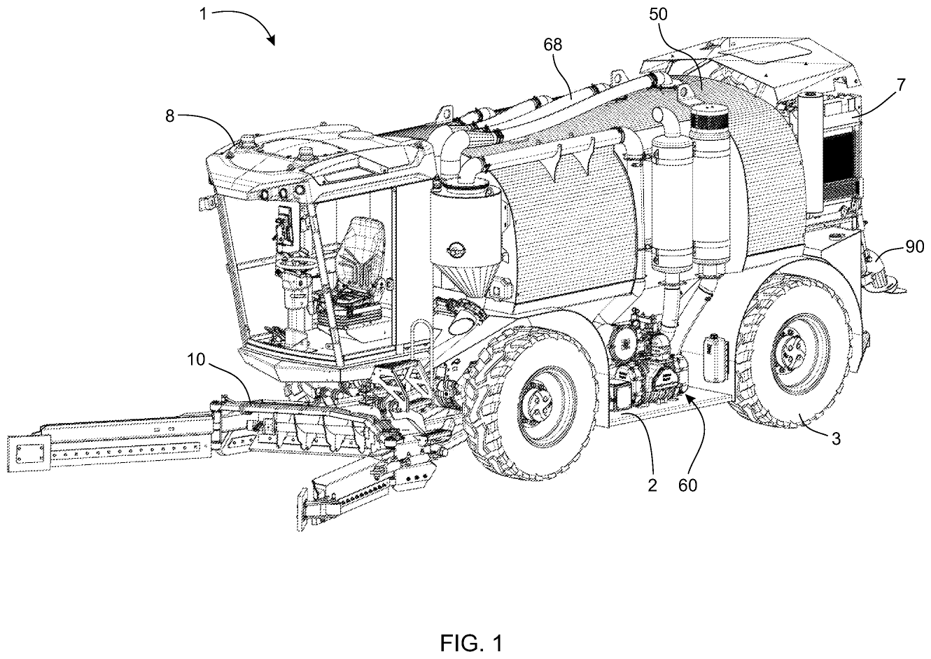

One embodiment of a manure collecting vehicle 1 is illustrated in FIG. 1. The manure collecting vehicle 1 comprises a chassis 2, a plurality of wheels 3 (only one labeled), a manure collector 10 mounted on the chassis 2 at a front of the vehicle 1 and a manure holding tank 50 supported on the chassis 2. The holding tank 50 is in communication through at least one manure handling conduit 68 (only one labeled) with the manure collector 10 to permit passage of collected manure from the manure collector 10 to the manure holding tank 50. The holding tank 50 comprises a tank outlet at a rear of the holding tank 50, the tank outlet terminating in a manure exit aperture through which the manure can exit from the holding tank 50. In the illustrated embodiment, the manure exit aperture is connected to a sprayer conduit 90 through which the manure can be sprayed in a fertilizing operation. During a manure collection operation, the sprayer conduit 90 is replaced with a door assembly to prevent the manure collected in the manure holding tank 50 from exiting through the tank outlet during the manure collection operation.

In the illustrated embodiment, the manure collecting vehicle 1 is self-propelled and therefore also comprises an engine 7 for operating the driven components of the vehicle 1 and a control cab 8 containing controls for the vehicle 1 and a place for an operator to occupy while controlling the vehicle 1. The illustrated embodiment of the manure collecting vehicle 1 is also vacuum-based, therefore the vehicle 1 further comprises a compact blower assembly 60 mounted on the chassis 2 for creating low air pressure (e.g., a vacuum) in the holding tank 50 to assist with collection of the manure, and, for creating high air pressure in the holding tank 50 to assist with ejecting the collected manure out through the tank outlet. The vehicle 1 has a longitudinal axis extending between the front and rear of the vehicle 1 horizontal with respect to the ground.

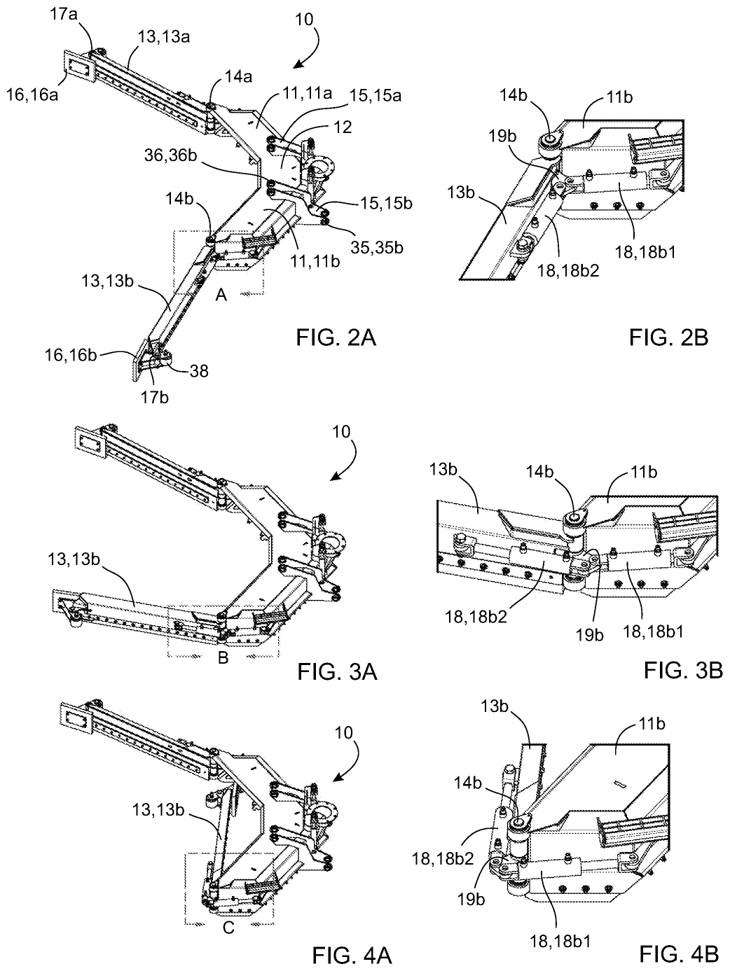

FIG. 2A to FIG. 7D illustrate the manure collector 10. The manure collector 10 comprises a center arm 11 having a pair of frontward and laterally extending arm sections 11a, 11b joined at an apex 12 proximate the vehicle chassis 2. The manure collector 10 further comprises a pair of end arms 13 pivotably mounted to the center arm 11, each of end arms 13a, 13b pivotably mounted to a respective one of the extending arm sections 11a, 11b through pivot pins 14a, 14b, respectively, at the distal ends of the arm sections 11a, 11b. The end arms 13a, 13b are each pivotable about respective vertical axes at the pivot pins 14a, 14b, respectively, so that distal ends of the end arms 13a, 13b move horizontally and laterally with respect to the direction of motion of the vehicle 1, as best seen in FIG. 2A to FIG. 4B. The distal ends of the end arms 13 are equipped with pivoting scrapers 16, each scraper 16a, 16b freely pivotally mounted to respective end arms 13a, 13b through pivot pins 17a, 17b, respectively. The end arms 13a, 13b are operatively pivotable to accommodate the width of an alleyway in a barn and the scrapers 16a, 16b are freely pivotable to align with raised edges of the alleyway in order to be able to scrape manure along the alleyway edges as the vehicle 1 is driven down the alleyway. Each of the scrapers 16 is further connected to a guide wheel 38 (only one labeled) located rearward of the scrapers 16. The guide wheels 38 contact and roll on an inward facing face of the alleyway edges when the end arms 13 and the scrapers 16 are oriented more longitudinally. The guide wheels 38 ensure that the scrapers 16 do not bind on the alleyway edges as the vehicle 1 is driven down the alleyway in a manure collection operation. Even with the presence of the guide wheels 38, the scrapers 16 freely pivot to always provide the best scrape angle to clean the alleyway edges. Operative adjustment of the end arms 13a, 13b and free pivoting of the scrapers 16a, 16b permits collection of manure from across the entire width of the alleyway as the vehicle 1 is driven down the alleyway. Typical alleyways have widths between 9′ and 16′, therefore the ability to operatively adjust the end arms 13a, 13b and the freely pivoting scrapers 16a, 16b contribute to the utility of the manure collector 10 in a large variety of barn environments.

The lateral orientations of the end arms 13 are operatively adjusted by pairs of arm actuators 18, a first pair of arm actuators (not shown) operating the end arm 13a and a second pair of arm actuators 18b1, 18b2 operating the end arm 13b. The pairs of arm actuators 18 operate in the same manner to operate the end arms 13 so the following discussion related to the end arm 13b applies in a similar manner to the operation of the end arm 13a. The arm actuators are illustrated as hydraulic cylinders but other types of actuators may be used instead of or in addition to hydraulic cylinders, for example electric linear actuators, pneumatic actuators, mechanical actuators and the like. As best seen in FIG. 2B, FIG. 3B and FIG. 4B with reference to the end arm 13b, the arm actuator 18b1 is mounted to a rear face of the arm section 11b in a channel behind the arm section 11b and the arm actuator 18b2 is mounted to a rear face of the end arm 13b behind the end arm 13b in series with the arm actuator 18b1. The arm actuator 18b1 is an inner arm actuator pivotally mounted at a proximal end thereof to the arm section 11b and pivotally mounted at a distal end thereof to a pivot plate 19b, the pivot plate 19b being mounted to the pivot pin 14b. The arm actuator 18b2 is an outer arm actuator pivotally mounted at a proximal end thereof to the pivot plate 19b and pivotally mounted at a distal end thereof to the end arm 13b. Mounting the arm actuators 18b1, 18b2 in channels behind the arm section 11b and the end arm 13b, respectively, protects the arm actuators 18b1, 18b2 from manure and other debris as the vehicle 1 is driven down the alleyway. With both arm actuators 18b1 and 18b2 fully retracted, the end arm 13b point laterally outward as seen in FIG. 2B. Extending the outer arm actuator 18b2 causes the end arm 13b to point more forwardly until the end arm 13b points directly forwardly when the outer arm actuator 18b2 is fully extended, as seen in FIG. 3B. Further extending the inner arm actuator 18b1 causes the end arm 13b to point more laterally inwardly, as seen in FIG. 4B. Operation of the two arm actuators 18b1 and 18b2 can be controlled to have the end arm 13b point in any desired forward direction through an angle of about 180° with respect to a lateral axis, the lateral axis being perpendicular to the longitudinal axis and the direction of travel of the vehicle 1. Thus, the end arm 13b can point directly laterally outward, directly laterally inward and at any angle in between. The ability to point the end arm 13b from a directly forward orientation (90° angle with respect to the lateral axis) to an inwardly lateral orientation (FIG. 4C) permits using the end arm 13b to ‘scoop’ manure toward the center arm 11 where a manure collection port is located.

The manure collector 10 further comprises mounting brackets 15 to permit mounting the manure collector 10 on the chassis 2 at the front of the vehicle 1. The mounting brackets 15 comprise a first pair of mounting brackets 15a attached to the arm section 11a and a second pair of mounting brackets 15b attached to the arm section 11b. The mounting brackets 15 comprise lower mounting apertures 35 (35a, 35b) and upper mounting apertures 36 (36a, 36b) that accept mounting pins through which linking bars can be pivotally connected to pivotally connect the manure collector 10 to the vehicle 1.

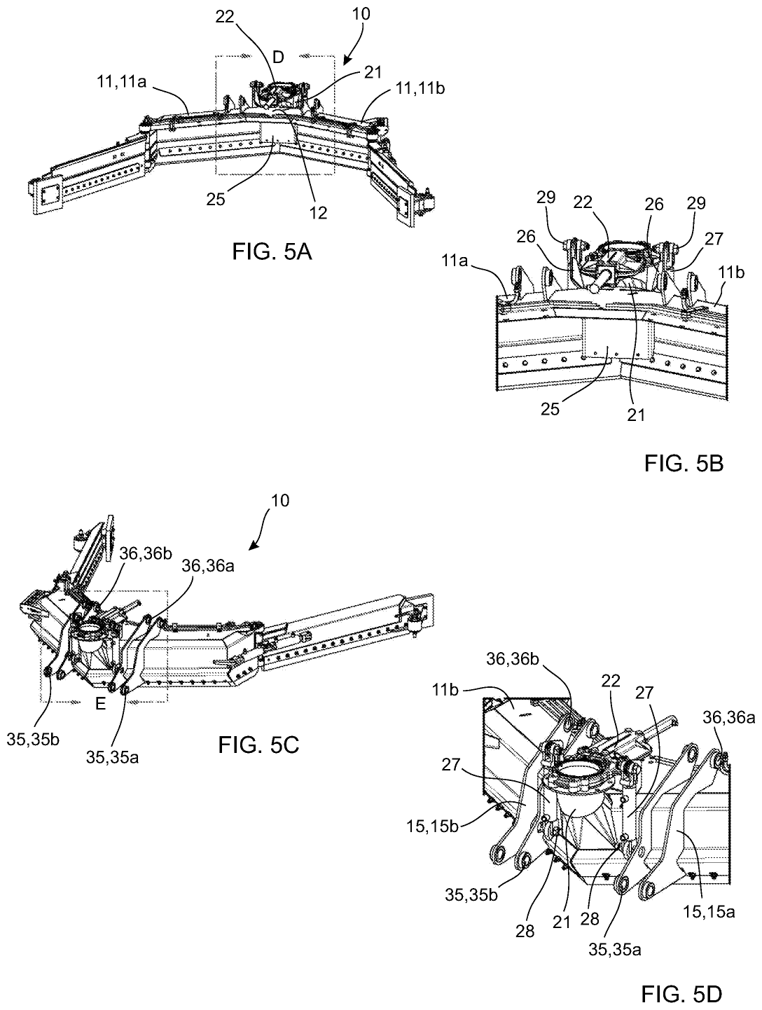

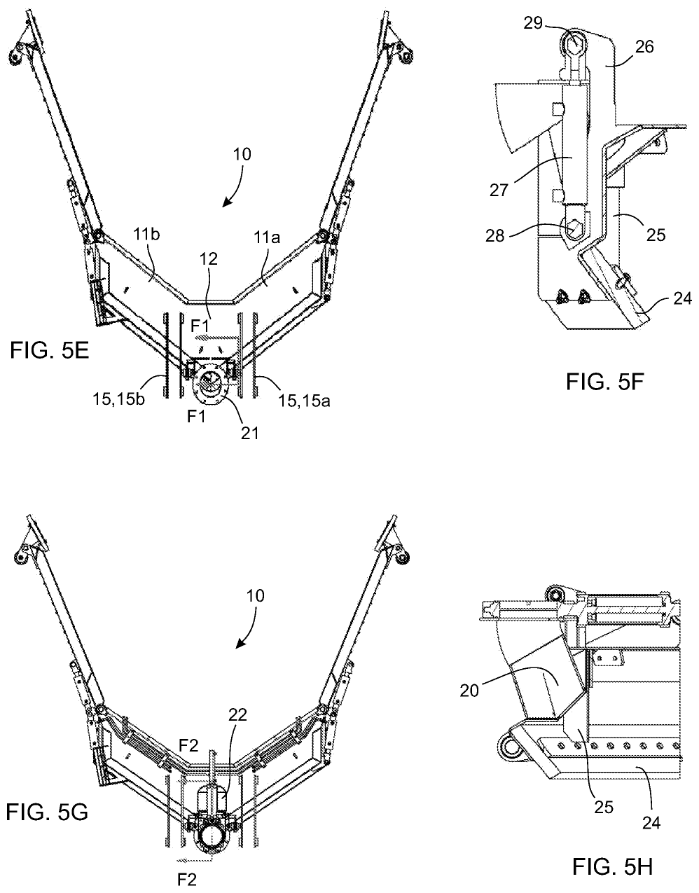

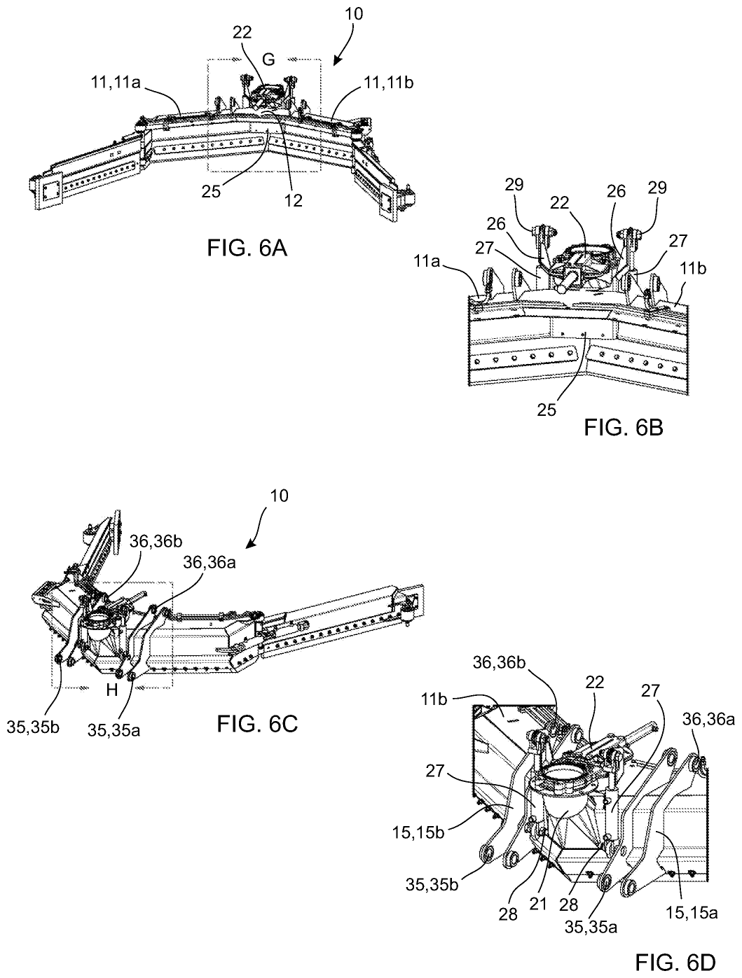

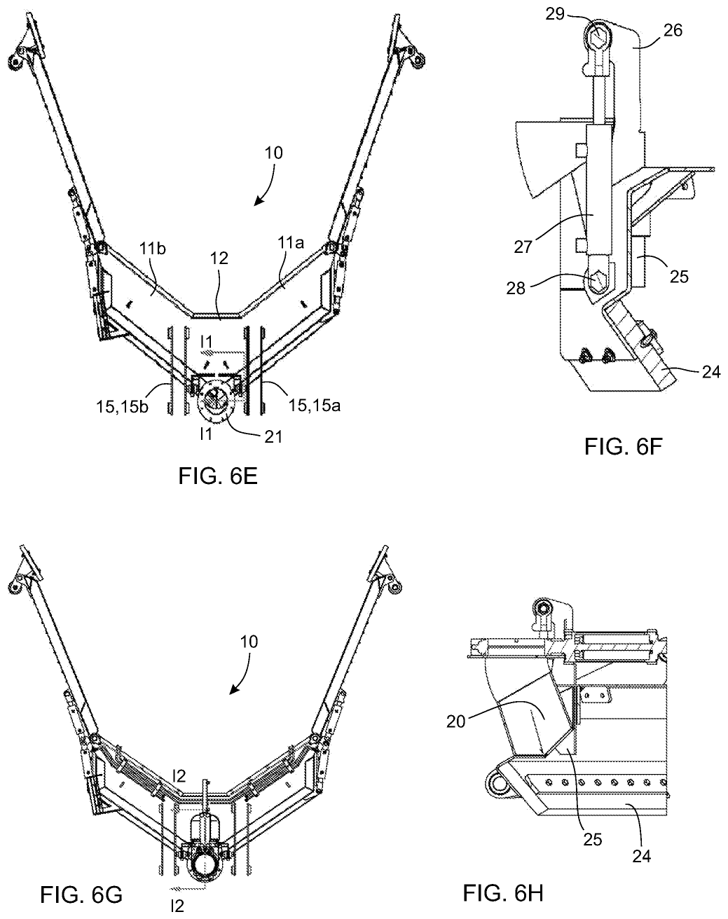

As best seen in FIG. 5A to FIG. 6H, the manure collector 10 further comprises a manure collection port 20 situated in a front face of the center arm 11 where the laterally extending arm sections 11a, 11b join at the apex 12. Further, lower portions of the front faces of the center arm 11 and the end arms 13 are equipped with rubber blade elements 24 that provide resilience and a more effective manure collection operation as manure is scraped off the ground. During operation of the manure collecting vehicle 1, manure is guided to the manure collection port 20 by the arms 11, 13 of the manure collector 10 where the manure is vacuumed through the port 20 by the blower assembly 60 into an inlet conduit 21, which leads to the holding tank 50 through at least one other of the manure handling conduits 68 in order to store the collected manure in the holding tank 50. The manure collection port 20 is equipped with a gate 25, which is operable to open/close and change the effective size of the manure collection port 20. Changing the size of the manure collection port 20 permits regulating pressure difference across the port 20 to assist with vacuuming the manure into the inlet conduit 21. Control over the size of the port 20 provides greater adaptability to manure conditions. For example, a large opening can be created when less pressure difference is needed but a larger opening is desired for more solid manure (FIG. 6A to FIG. 6F), while a small opening can be created when a greater pressure difference is needed but a smaller opening is suitable for more liquid manure (FIG. 5A to FIG. 5F). The gate 25 can be raised and lowered by one or more gate actuators 27 pivotally mounted to the center arm 11 at pivot pin 28 and pivotally connected to a gate flange 26 of the gate 25 at pivot pin 29. The illustrated embodiment comprises two gate actuators 27, one situated at each lateral side of the gate 25, the two gate actuators 27 working in tandem to open and close the gate 25. The gate actuators are illustrated as hydraulic cylinders but other types of actuators may be used instead of or in addition to hydraulic cylinders, for example electric linear actuators, pneumatic actuators, mechanical actuators and the like. A shut-off valve 22 provided at the inlet conduit 21 is operable so that the manure handling conduit connected to the inlet conduit 21 does not spill or drip manure and make a mess after a manure collection operation.

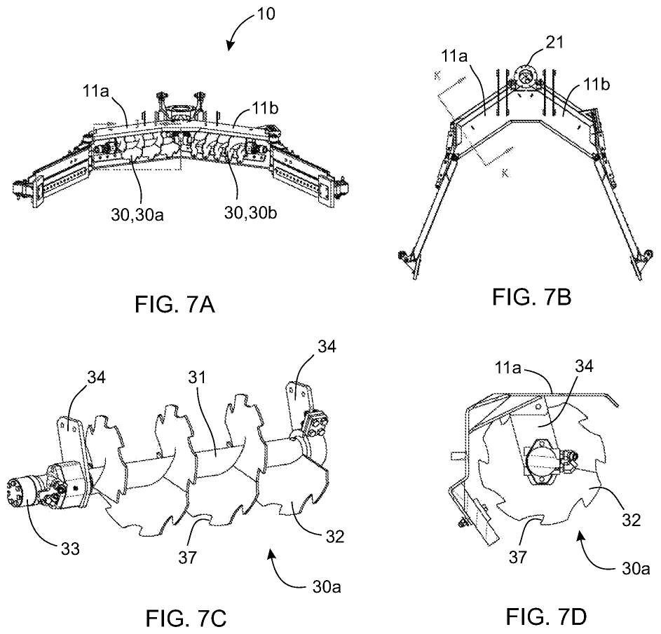

To assist with gathering manure toward the collection port 20, the manure collector 10 comprises at least one powered rotational manure conveyer configured to convey manure to be collected to the manure collection port 20 as the vehicle 1 drives through the manure to be collected. The at least one powered rotational manure conveyer conveys manure laterally inwardly toward port 20 from both sides of the manure collector 10. The rotational manure conveyer may comprise a screw conveyor, a belt conveyor or the like. As best seen in FIG. 7A to FIG. 7D, the illustrated embodiment comprises a powered rotational manure conveyer 30 in the form of a pair of augers (screw conveyors) 30a, 30b. The augers 30a, 30b are incorporated into the manure collector 10 by being respectively rotationally mounted in the arm sections 11a, 11b. The augers 30a, 30b have rotational axes oriented parallel to longitudinal axes of the respective arm sections 11a, 11b. The arm sections 11a, 11b are open-faced forward and downward while being close-faced rearward and upward so that manure can be collected and contained by the arm sections 11a, 11b and moved toward the port 20 by the augers 30a, 30b as the vehicle 1 drives through the manure to be collected. With reference to the auger 30a, as seen in FIG. 7C and FIG. 7D, each of the augers 30a, 30b comprise a shaft 31 around which an auger blade 32 mounted to form a screw. The shaft 31 is driven by a variable speed motor 33, for example a hydraulic motor or an electric motor, situated proximate a laterally outward end of the shaft 31. The augers 30a, 30b are mounted to the respective arm sections 11a, 11b through mounting plates 34 at each end of each of each of the augers 30a, 30b. The variable speed motors 33 permit better control over auger speed, being able to drive the augers 30a, 30b at different speeds to adapt to the manure conditions. For example, lower speeds are better for manure of more solid consistency to avoid plugging the port 20 while higher speeds are better for manure of more liquid consistency to propel the manure more vigorously toward the port 20. The rotational manure conveyor 30 is angled and pitched to push manure back behind the rotational manure conveyor 30 into the center arm 11 as the rotational manure conveyor 30 rotates. Thus, as the manure is conveyed toward the manure collection port 20 by the rotational manure conveyor 30, the rotational manure conveyor 30 is able to pick up more manure. The rotational manure conveyor 30 is thus designed to reduce or eliminate ‘bridging’ where solid manure just packs in front of the center arm 11 and does not feed into the manure collection port 20. Further, when the rotational manure conveyor 30 comprises the augers 30a, 30b, the auger blades 32 comprise notches 37 to help cut up thick manure as the manure is conveyed in the center arm 11.

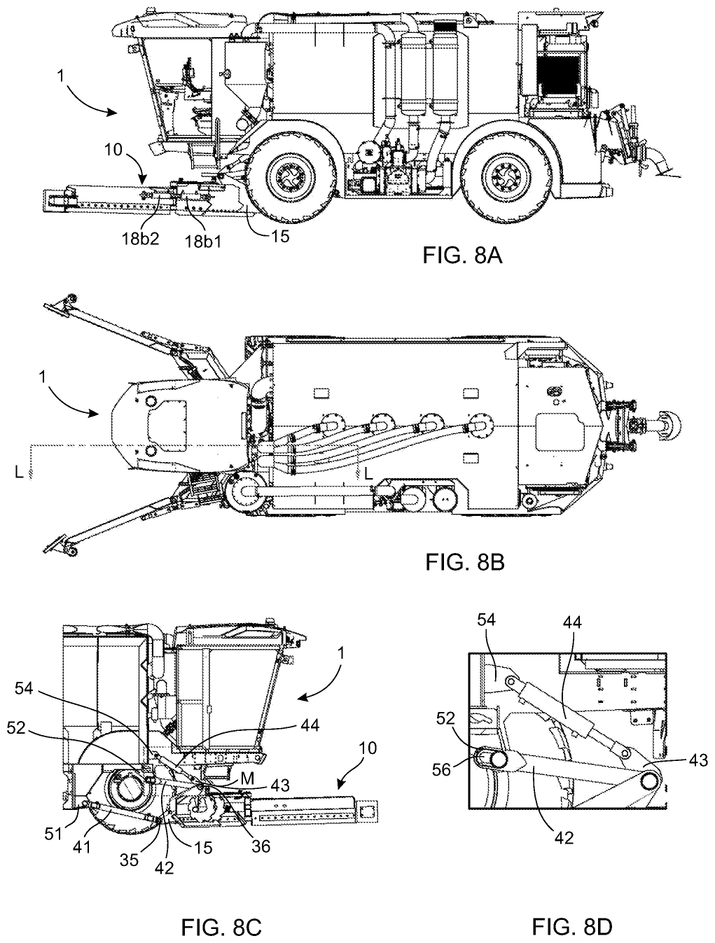

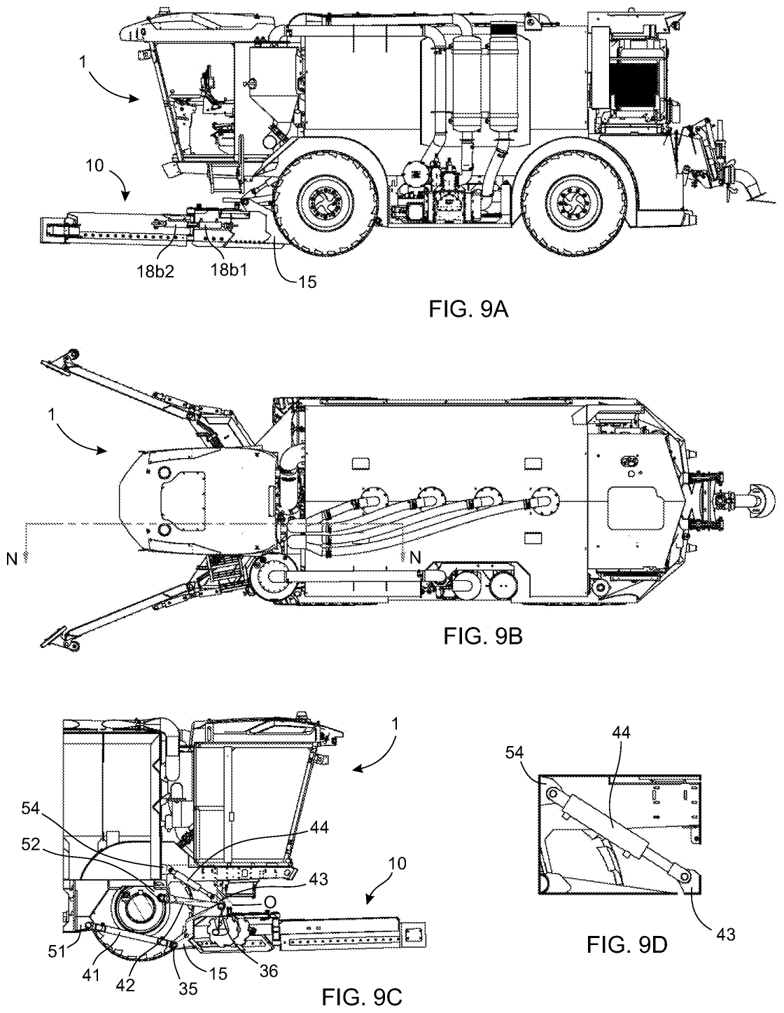

As shown in FIG. 8A to FIG. 9D, the manure collector 10 can be raised and lowered between a raised position and a lowered position while being mounted on the vehicle 1. In the illustrated embodiment, the manure collector 10 is mounted to the vehicle 1 by pivoting connectors situated on each side of the apex 12 of the manure collector 10. The pivoting connectors connect the mounting brackets 15 of the manure collector 10 to connection points on the vehicle 1. The following describes one set of the pivoting connectors, but the description is equally applicable to the other set of connectors. As best seen in FIG. 8C and FIG. 9C, the pivoting connectors comprise a first linking bar 41, a second linking bar 42, a third linking bar 43 and a collector actuator 44. The collector actuator is illustrated as a hydraulic cylinder but other type of actuators may be used instead of or in addition to a hydraulic cylinder, for example an electric linear actuator, a pneumatic actuator, a mechanical actuator and the like. The first linking bar 41 is pivotally connected to the lower mounting apertures 35 of the mounting bracket 15 and is also pivotally connected to a first support 51 on the chassis 2 of the vehicle 1. The second linking bar 42 is pivotally connected to the upper mounting apertures 36 of the mounting bracket 15 and is also pivotally connected to a second support 52 on the vehicle 1. The third linking bar 43 is pivotally connected to the upper mounting apertures 36 of the mounting bracket 15. The collector actuator 44 is pivotally connected to a third support 54 on the vehicle 1 and is also pivotally connected to the third linking bar 43. The first support 51, the second support 52 and the third support 54 are at different vertical heights with the first support 51 being lower than the second support 52, the second support 52 being lower than the third support 54. When the collector actuator 44 is fully extended as seen in FIG. 8C, the manure collector 10 is lowered into the lowered position. When the collector actuator 44 is fully retracted as seen in FIG. 9C, the manure collector 10 is raised into the raised position. In addition to the entire manure collector 10 being raised and lowered vertically, the manure collector 10 is tilted in the raised position so that the distal ends of the end arms 13 are vertically higher than distal ends of the arm sections 11a, 11b, which gives the manure collector 10 a better angle of approach to the manure. Further, when the vehicle 1 is driving up a ramp to enter into the alleyway, tilting the manure collector 10 in this manner provides more ground clearance. A slot 56 is provided in the second support 52 where the second linking bar 42 is pivotally connected, which allows for movement and floating of the manure collector 10 because as the collector actuator 44 retracts, the second linking bar 42 moves back to the end of the slot 56 to permit vertical pivoting of the manure collector 10.

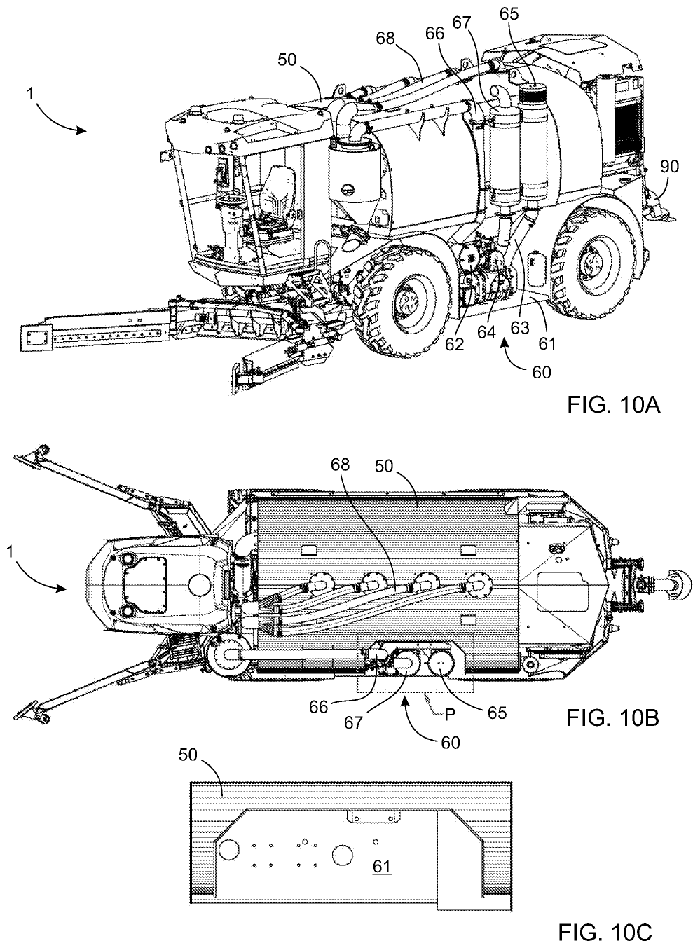

Referring to FIG. 10A to FIG. 100, the manure collecting vehicle 1 having an air system comprising the blower assembly 60 is shown. The vehicle 1 comprises a compact cutout 61 in a side of the holding tank 50, which conveniently provides a single compact space for the compact blower assembly 60. The blower assembly 60 comprises a blower 62 with a silencer 67 in fluid communication with an interior of the holding tank 50 through air conduits 63 (only one labeled). The blower assembly 60 comprises a four-port valve 64 to selectively create a dual inlet when the blower assembly 60 is in discharge mode. The blower assembly 60 further comprises a cooling box 65 to plumb both a cooling air inlet and an exhaust outlet through a same inlet/outlet conduit 66. All of the components of the blower assembly 60 are co-located in the same compact cutout 61 in the side of the holding tank 50 to provide a more compact and slim profile vehicle.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A manure collecting vehicle comprising:
a manure collector having a manure collection port and at least one powered rotational manure conveyer configured to convey manure to be collected to the manure collection port as the vehicle drives through the manure to be collected;
a manure holding tank mounted on a vehicle chassis, the manure holding tank in manure communication with the manure collection port, the collected manure passing through the manure collection port into the manure holding tank as the vehicle drives through the manure to be collected; and,
an air system configured to create an air pressure differential between inside the manure holding tank and outside the manure holding tank when the vehicle is driving through the manure to be collected so that the collected manure passes from the manure collection port into the manure holding tank under influence of the air pressure differential.

2. The vehicle of claim 1, wherein the air system is configured to lower the air pressure inside the manure holding tank compared to outside the manure holding tank so that the collected manure passes from the manure collection port into the manure holding tank.

3. The vehicle of claim 1, wherein the manure holding tank comprises a tank outlet and the air system is configured to raise the air pressure inside the manure holding tank compared to outside the manure holding tank so that the collected manure inside the manure holding tank is ejected through the tank outlet.

4. The vehicle of claim 1, wherein the manure holding tank comprises a mechanical manure transporting apparatus to transport the collected manure out of the manure holding tank.

5. The vehicle of claim 1, wherein the at least one powered rotational manure conveyer comprises at least one auger.

6. The vehicle of claim 1, wherein the at least one powered rotational manure conveyer comprises a variable speed motor that drives the conveyer at different speeds.

7. The vehicle of claim 1, wherein the manure collector is vertically adjustable relative to the vehicle chassis.

8. The vehicle of claim 7, wherein the manure collector comprises one or more collector actuators connecting the manure collector to the vehicle whereby actuation of the one or more collector actuators vertically adjusts the manure collector relative to the vehicle chassis.

9. The vehicle of claim 1, wherein manure collection comprises a gate operable to change the size of the manure collection port.

10. The vehicle of claim 9, wherein the manure collector comprises one or more gate actuators connected to the gate, the one or more gate actuators configured to move the gate to change the size of the manure collection port.

11. The vehicle of claim 1, wherein the manure collector is mounted on the vehicle chassis at a front of the vehicle with respect to direction of motion of the vehicle during a manure collection operation, and the manure collector comprises:
a center arm mounted on the vehicle, the center arm having a pair of frontwardly and laterally extending arm sections joined at an apex proximate the vehicle chassis, the manure collection port situated proximate the apex, the at least one powered rotational manure conveyer comprising at least two powered rotational manure conveyers, the at least two powered rotational manure conveyers conveying manure along each of the extending arm sections from distal ends thereof to the manure collection port; and,
a pair of end arms pivotably mounted to the center arm, each of the end arms pivotably mounted to a respective one of the extending arm sections at the distal ends thereof, each of the end arms pivotable about a respective vertical axis so that distal ends of the end arms move horizontally and laterally with respect to the direction of motion of the vehicle.

12. The vehicle of claim 11, further comprising two pairs of arm actuators configured to pivot the end arms about the respective vertical axes, each pair of arm actuators comprising an inner arm actuator and an outer arm actuator mounted in series with the inner arm actuator through a common pivot plate, the inner arm actuator pivotally mounted to a rear face one of the arm sections, the outer arm actuator pivotally mounted to a rear face of the end arm that is connected to the arm section to which the inner arm actuator is mounted.

13. The vehicle of claim 11, wherein the manure collector is tiltable so that the distal ends of the end arms are vertically higher than the distal ends of the arm sections.

14. The vehicle of claim 11, wherein the distal ends of the end arms comprise pivoting scrapers and the manure to be collected is guided toward the manure collection port by the end arms and the extending arm sections during the manure collection operation.

15. The vehicle of claim 14, wherein the distal ends of the end arms further comprise guide wheels connected to the pivoting scrapers, the guide wheels configured to be able to contact and roll on inward facing faces of alleyway edges as the vehicle drives down an alleyway.

16. The vehicle of claim 11, wherein the vehicle further comprises a shut-off valve provided between the manure collection port and the manure holding tank in manure communication with the manure collection port, the shut-off valve operable so that a manure handling conduit connecting the manure collection port to the manure holding tank does not spill or drip manure after the manure collection operation.

17. The vehicle of claim 1, further comprising an engine for operating driven components of the vehicle so that the vehicle is self-propelled.

18. The vehicle of claim 1, wherein the air system comprises a blower assembly having a blower, a silencer, a cooling box and a four-port valve co-located in a cutout in a side of the holding tank, the four-port valve selectively creating a dual inlet when the blower assembly is in discharge mode.

19. The vehicle of claim 18, wherein the cooling box is plumbed to provide both a cooling air inlet and an exhaust outlet through a same inlet/outlet conduit.
